(19) United States
(12) Patent Application Publication
(10) Pub. No.: US 2024/0383253 A1
(43) Pub. Date: Nov. 21, 2024

(54) LIQUID EJECTION DEVICE CAPABLE OF SUPPRESSING DRYING OF LIQUID SURFACE OF EJECTION PORT, AND LIQUID CIRCULATION METHOD

(71) Applicant: KYOCERA Document Solutions Inc., Osaka-shi (JP)

(72) Inventor: Shogo Yoneda, Osaka (JP)

(21) Appl. No.: 18/662,501

(22) Filed: May 13, 2024

(30) Foreign Application Priority Data
May 19, 2023 (JP) 2023-082863

(51) Int. Cl. B41J 2/175; B41J 2/045; B41J 2/18

(52) U.S. Cl. CPC B41J 2/175; B41J 2/04501; B41J 2/18; B41J 2202/12

(57) ABSTRACT

A liquid ejection device includes an ejection portion, an accommodating portion, a lowering processing portion, and a circulation processing portion. The ejection portion has a first accommodation space configured to accommodate a liquid and eject the liquid from an ejection port communicating with the first accommodation space. The accommodating portion has a second accommodation space below the ejection port and configured to accommodate the liquid to be supplied to the ejection portion, in the accommodating portion, a space above a water level of the liquid accommodated in the second accommodation space communicates with the atmosphere. The lowering processing portion lowers the water level of the liquid accommodated in the accommodating portion with respect to the ejection port. The circulation processing portion circulates the liquid along a circulation path passing through the ejection portion after the water level of the liquid is lowered by the lowering processing portion.

### INCORPORATION BY REFERENCE

This application is based upon and claims the benefit of priority from the corresponding Japanese Patent Application No. 2023-082863 filed on May 19, 2023, the entire contents of which are incorporated herein by reference.

### BACKGROUND

The present disclosure relates to a liquid ejection device and a liquid circulation method.

An inkjet-type image forming apparatus includes an ejection portion that ejects ink. The ejection portion has an accommodation space that accommodates ink, and ejects the ink accommodated in the accommodation space from an ejection port that communicates with the accommodation space. In addition, as related art, an inkjet recording apparatus is known in which, in order to suppress drying of a liquid surface of the ink formed in the ejection port, the accommodation space is expanded to suck the ink from the ejection port into the accommodation space, and then the ink is circulated along a circulation path passing through the accommodation space.

### SUMMARY

The liquid ejection device according to one aspect of the present disclosure includes an ejection portion, an accommodating portion, a lowering processing portion, and a circulation processing portion. The ejection portion has a first accommodation space configured to accommodate a liquid and eject the liquid accommodated in the first accommodation space from an ejection port communicating with the first accommodation space. The accommodating portion has a second accommodation space below the ejection port and configured to accommodate the liquid to be supplied to the ejection portion, in the accommodating portion, a space above a water level of the liquid accommodated in the second accommodation space communicates with the atmosphere. The lowering processing portion lowers the water level of the liquid accommodated in the accommodating portion with respect to the ejection port. The circulation processing portion circulates the liquid along a circulation path passing through the ejection portion after the water level of the liquid is lowered by the lowering processing portion.

A liquid circulation method according to another aspect of the present disclosure is executed by a liquid ejection device, the liquid ejection device including: an ejection portion having a first accommodation space configured to accommodate a liquid and eject the liquid accommodated in the first accommodation space from an ejection port communicating with the first accommodation space; and an accommodating portion having a second accommodation space below the ejection port and configured to accommodate the liquid to be supplied to the ejection portion, in the accommodating portion, a space above a water level of the liquid accommodated in the second accommodation space communicates with atmosphere; the liquid circulation method including a lowering step and a circulation step. In the lowering step, a water level of the liquid accommodated in the accommodating portion is lowered with respect to the ejection port. In the circulation step, the liquid is circulated along a circulation path passing through the ejection portion after the water level of the liquid is lowered by the lowering step.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing a configuration of an image forming apparatus of an embodiment according to the present disclosure.

FIG. 2 is a diagram showing a configuration of an image forming portion and a conveying unit of an image forming apparatus of an embodiment according to the present disclosure.

FIG. 3 is a block diagram showing a system configuration of an image forming apparatus of an embodiment according to the present disclosure.

FIG. 4 is a diagram showing a configuration of a recording head, an ink supply portion, and an ink circulation portion of an image forming apparatus of an embodiment according to the present disclosure.

FIG. 5 is a flowchart illustrating an example of an ink circulation process executed by an image forming apparatus of an embodiment according to the present disclosure.

FIG. 6 is a block diagram showing a system configuration of an image forming apparatus of another embodiment according to the present disclosure.

### DETAILED DESCRIPTION

Embodiments of the present disclosure will be described below with reference to the accompanying drawings. Note that the following embodiments are examples of embodying a technique according to the present disclosure, and do not limit the technical scope of the present disclosure.

### [Configuration of Image Forming Apparatus 100]

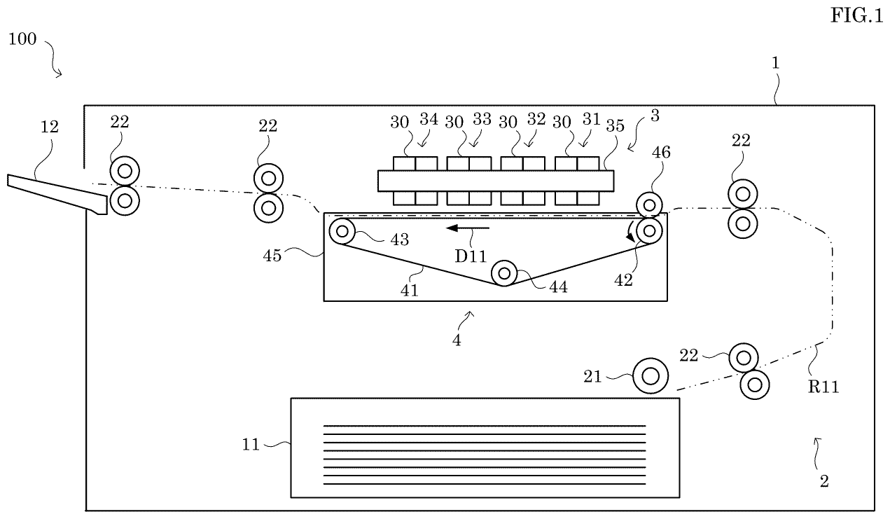

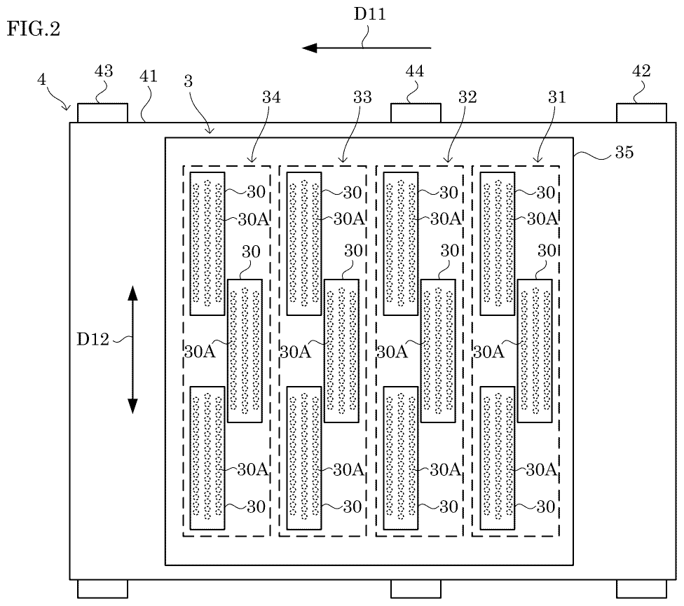

First, a configuration of an image forming apparatus 100 of an embodiment according to the present disclosure will be described with reference to FIGS. 1 to 3. Here, FIG. 1 is a cross-sectional view showing the configuration of the image forming apparatus 100. In addition, FIG. 2 is a plan view showing a configuration of an image forming portion 3 and a conveying unit 4. Note that in FIG. 1, a sheet conveying path R11 is indicated by a two-dot chain line.

The image forming apparatus 100 is a printer capable of forming an image on a sheet using an inkjet method. Note that the technique according to the present disclosure may be applied to image forming apparatuses such as facsimile machines, copiers, and multifunction peripherals capable of forming images on sheets using an inkjet method.

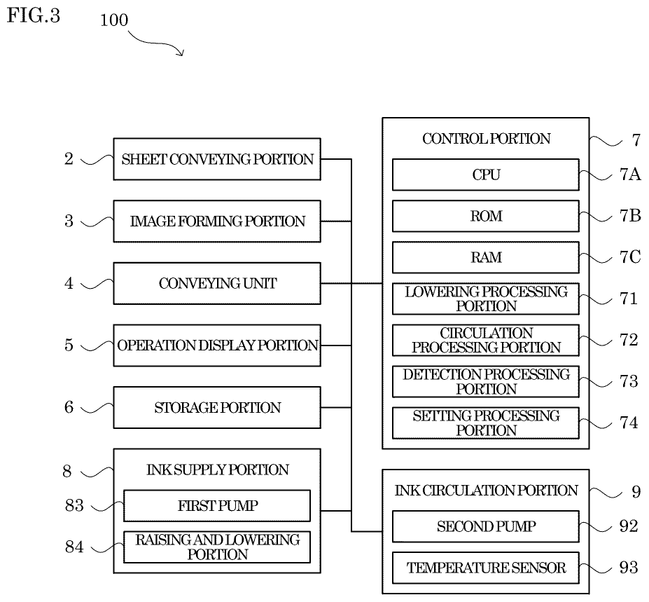

As shown in FIGS. 1 and 3, the image forming apparatus 100 includes a housing 1, a sheet conveying portion 2, an image forming portion 3, a conveying unit 4, an operation display portion 5, a storage portion 6, a control portion 7, an ink supply portion 8 and an ink circulation portion 9.

The housing 1 houses each component of the image forming apparatus 100. A sheet feed cassette 11 is removably provided in the housing 1. The sheet feed cassette 11 accommodates sheets on which images are to be formed. A sheet discharge tray 12 is provided at an outer surface of the housing 1. A sheet on which an image has been formed by the image forming portion 3 is discharged to the sheet discharge tray 12. Inside the housing 1, the sheets accommodated in the sheet feed cassette 11 are conveyed along the sheet conveying path R11 (see FIG. 1) that passes through an image forming position of the image forming portion 3 and reaches the sheet discharge tray 12.

The sheet conveying portion 2 conveys the sheets accommodated in the sheet feed cassette 11 along the sheet conveying path R11 (see FIG. 1). As shown in FIG. 1, the sheet conveying portion 2 includes a pickup roller 21 and a plurality of conveying rollers 22. The pickup roller 21 picks up the uppermost sheet of a sheet bundle accommodated in the sheet feed cassette 11, and feeds the sheet to the sheet conveying path R11. The plurality of conveying rollers 22 are arranged in line along the sheet conveying path R11. Each of the conveying rollers 22 conveys the sheet along the sheet conveying path R11. Each of the conveying rollers 22 convey the sheet in a conveying direction D11 (see FIG. 1) from the sheet feed cassette 11 toward the sheet discharge tray 12.

The image forming portion 3 forms an image on the sheet supplied from the sheet conveying portion 2 based on image data. As shown in FIG. 1, the image forming portion 3 includes line heads 31 to 34 and a head frame 35.

As shown in FIG. 2, each of the line heads 31 to 34 is elongated in a width direction D12 orthogonal to the conveying direction D11. More specifically, each of the line heads 31 to 34 has a length in the width direction D12 that corresponds to a width of a largest sheet among the sheets that can be accommodated in the sheet feed cassette 11. Each of the line heads 31 to 34 is arranged at regular intervals along the conveying direction D11.

As shown in FIG. 2, each of the line heads 31 to 34 has a plurality of recording heads 30. The recording heads 30 eject ink toward the sheet conveyed by the conveying unit 4. More specifically, a large number of nozzles 30A (see FIG. 2) used for ejecting the ink are provided on a surface of the recording head 30 that faces the sheet. Each of the recording heads 30 provided in the line head 31 discharges black ink. Each of the recording heads 30 provided in the line head 32 discharges cyan ink. Each of the recording heads 30 provided in the line head 33 discharges magenta ink. Each of the recording heads 30 provided in the line head 34 discharges yellow ink.

In the present embodiment, the line head 31 has three recording heads 30 arranged in a staggered manner along the width direction D12. In addition, in each of the other line heads 32 to 34, similar to the line head 31, three recording heads 30 are arranged in a staggered manner along the width direction D12. Note that FIG. 2 shows the image forming portion 3 in a state as viewed from above in FIG. 1.

The head frame 35 supports the line heads 31 to 34. The head frame 35 is supported by the housing 1. Note that the number of line heads included in the image forming portion 3 may be any number including one. Moreover, the number of recording heads 30 provided in each of the line heads 31 to 34 may be any number.

As shown in FIG. 1, the conveying unit 4 is arranged below the line heads 31 to 34. The conveying unit 4 conveys the sheet while causing the sheet to face the recording heads 30. For example, the conveying unit 4 conveys the sheet by a predetermined conveying amount each time the recording head 30 discharges the ink. In addition, the conveying unit 4 stops conveying the sheet while the recording head 30 is ejecting the ink. As shown in FIG. 1, the conveying unit 4 includes a conveying belt 41 on which a sheet is placed, a first tension roller 42, a second tension roller 43, and a third tension roller 44, which stretch the conveying belt 41, and a conveying frame 45 that supports these components. Note that a gap between the conveying belt 41 and the recording heads 30 is adjusted so that a gap between a surface of the sheet and the recording heads 30 during image formation is a predetermined distance (for example, 1 mm).

The first tension roller 42 is rotationally driven by a rotational driving force supplied from a motor (not shown). Thus, the conveying belt 41 rotates in a direction in which the sheet can be conveyed in the conveying direction D11 (see FIG. 1). Note that the conveying unit 4 is also provided with a suction unit (not shown) that sucks air through a large number of through holes formed in the conveying belt 41 in order to attract the sheet to the conveying belt 41. In addition, a pressure roller 46 is provided above the first tension roller 42 to press the sheet against the conveying belt 41 and convey the sheet.

The operation display portion 5 includes a display portion such as a liquid crystal display that displays various types of information according to control instructions from the control portion 7, and an operation portion such as operation keys or a touch panel that inputs various types of information to the control portion 7 according to user operations. The operation display portion 5 is provided on an upper surface of the housing 1.

The storage portion 6 is a non-volatile storage device. For example, the storage portion 6 is a non-volatile memory such as a flash memory.

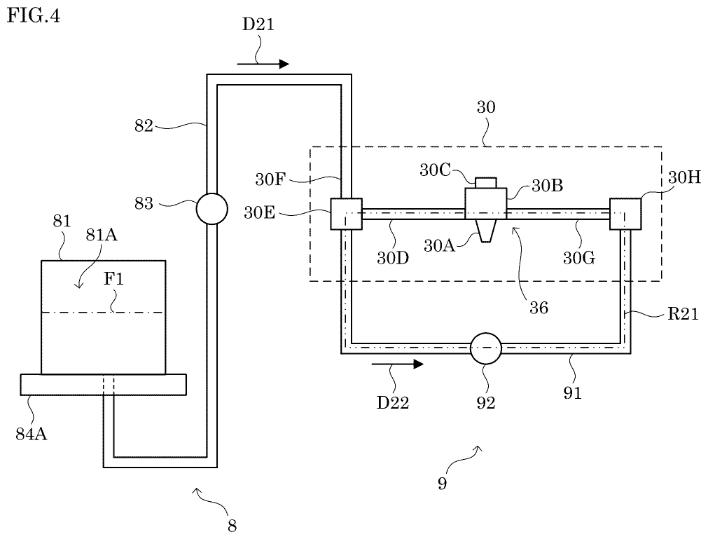

The control portion 7 performs overall control of the image forming apparatus 100. As shown in FIG. 3, the control portion 7 includes a CPU 7A, a ROM 7B, and a RAM 7C. The CPU 7A is a processor that executes various types of calculation processes. The ROM 7B is a non-volatile storage device in which information such as control programs for causing the CPU 7A to execute various types of processes is stored in advance. The RAM 7C is a volatile or non-volatile storage device used as a temporary storage memory (work area) for various types of processes executed by the CPU 7A. The CPU 7A performs overall control of the image forming apparatus 100 by executing various types of control programs stored in advance in the ROM 7B. Note that the control portion 7 may be a control portion provided separately from a main control portion that performs overall control of the image forming apparatus 100. In addition, the control portion 7 may be configured with an electronic circuit such as an integrated circuit (ASIC).

[Configuration of Recording Head 30, Ink Supply Portion 8, and Ink Circulation Portion 9]Next, the configurations of the recording head 30, the ink supply portion 8, and the ink circulation portion 9 will be described with reference to FIGS. 3 and 4. Note that in FIG. 4, a water level F1 of the ink is shown by a one-dot chain line. In addition, in FIG. 4, a circulation path R21 is indicated by a two-dot chain line.

As shown in FIG. 4, the recording head 30 includes a pressurizing chamber 30B, a piezoelectric element 30C, a first individual flow path 30D, and a second individual flow path 30G corresponding to each nozzle 30A. Moreover, the recording head 30 also includes a first common flow path 30E, a communication flow path 30F, and a second common flow path 30H common to the plurality of nozzles 30A.

The pressurizing chamber 30B communicates with the nozzle 30A and accommodates the ink. The piezoelectric element 30C causes the ink to be ejected from the nozzle 30A in response to application of a predetermined drive voltage. More specifically, the piezoelectric element 30C causes the ink to be ejected from the nozzle 30A by vibrating a wall surface of the pressurizing chamber 30B in response to the application of the drive voltage.

The nozzle 30A, the pressurizing chamber 30B, and the piezoelectric element 30C constitute an ejection portion 36 (see FIG. 4) that ejects the ink. The ejection portion 36 has the pressurizing chamber 30B (an example of a first accommodation space according to the present disclosure) that accommodates the ink (an example of a liquid according to the present disclosure), and causes the ink accommodated in the pressurizing chamber 30B to be ejected from the nozzle 30A (an example of an ejection port according to the present disclosure) that communicates with the pressurizing chamber 30B.

The first individual flow path 30D is an ink flow path provided between the pressurizing chamber 30B and the first common flow path 30E. A plurality of first individual flow paths 30D corresponding to the plurality of nozzles 30A are connected to the first common flow path 30E. The communication flow path 30F is an ink flow path that communicates a supply flow path 82 of the ink supply portion 8 and the first common flow path 30E.

The second individual flow path 30G is an ink flow path provided between the pressurizing chamber 30B and the second common flow path 30H. A plurality of second individual flow paths 30G corresponding to the plurality of nozzles 30A are connected to the second common flow path 30H.

The ink supply portion 8 supplies the ink to the recording heads 30. The ink supply portion 8 is provided for each recording head 30.

As shown in FIG. 4, the ink supply portion 8 includes a sub-ink tank 81, a supply flow path 82, and a first pump 83.

The sub-ink tank 81 has, below the nozzle 30A, an ink accommodation space 81A (see FIG. 4) (an example of a second accommodation space according to the present disclosure) that accommodates the ink to be supplied to the ejection portion 36, in the sub-ink tank 81, a space above the water level F1 (see FIG. 4) of the ink accommodated in the ink accommodation space 81A communicates with the atmosphere. The sub-ink tank 81 is an example of an accommodating portion according to the present disclosure.

The ink is supplied to the sub-ink tank 81 from an ink container (not shown). For example, the sub-ink tank 81 is provided with a water level sensor that detects the water level of the ink accommodated in the ink accommodation space 81A. The control portion 7, based on the detection result by the water level sensor, controls the supply of the ink from the ink container to the sub-ink tank 81 so that the water level of the ink accommodated in the ink accommodation space 81A becomes a predetermined reference water level. Thus, the distance in the vertical direction between the nozzle 30A and the water level F1 of the ink accommodated in the ink accommodation space 81A is kept constant.

For example, the ink supplied to the sub-ink tank 81 is an aqueous ink whose main solvent is water. Note that the ink may be a non-aqueous ink whose main solvent is an organic solvent.

Note that the image forming apparatus 100 does not need to include the sub-ink tank 81. That is, the recording head 30 may receive the supply of ink directly from the ink container. In this case, the ink container may be any accommodation portion according to the present disclosure.

The supply flow path 82 is an ink flow path provided between the sub-ink tank 81 and the recording head 30. The supply flow path 82 is formed of a flexible material.

For example, the supply flow path 82 is a tube made of resin.

The first pump 83 is provided in the supply flow path 82. The first pump 83 causes the ink in the supply flow path 82 to flow in a flow direction D21 (see FIG. 4) toward the recording head 30.

The ink circulation portion 9 circulates the ink along the circulation path R21 (see FIG. 4) passing through the ejection portion 36.

As shown in FIGS. 3 and 4, the ink circulation portion 9 includes a circulation flow path 91, a second pump 92, and a temperature sensor 93.

The circulation flow path 91 is an ink flow path that extends from the first common flow path 30E of the recording head 30 to the second common flow path 30H of the recording head 30 via an outer portion of the recording head 30. The ejection portion 36, the first individual flow path 30D, the first common flow path 30E, the circulation flow path 91, the second common flow path 30H, and the second individual flow path 30G constitute the circulation path R21 that passes through the ejection portion 36 (see FIG. 4). Note that the circulation path according to the present disclosure may be configured to pass through the sub-ink tank 81.

The second pump 92 is provided in the circulation flow path 91. The second pump 92 causes the ink in the circulation flow path 91 to flow in a flow direction D22 (see FIG. 4) shown in FIG. 4.

The temperature sensor 93 is provided in the circulation flow path 91 and detects the temperature of the ink flowing in the circulation flow path 91. Note that the temperature sensor 93 may be provided within the recording head 30. In addition, the temperature sensor 93 may be provided in the supply flow path 82.

In order to suppress drying of the liquid surface of the ink formed in the nozzle 30A, an inkjet recording apparatus is known as related art in which the pressurizing chamber 30B is expanded to suck the ink from the nozzle 30A into the pressurizing chamber 30B, and then the ink is circulated along the circulation path R21.

However, in the inkjet recording apparatus according to the related art, in order to maintain a state in which the ink in the nozzle 30A is sucked into the pressurizing chamber 30B, it is necessary to continuously supply electric power to the piezoelectric element 30C used for expanding and deflating the pressurizing chamber 30B.

In contrast, in the image forming apparatus 100 of an embodiment according to the present disclosure, as will be described below, it is possible to suppress drying of the liquid surface of the ink formed in the nozzle 30A while suppressing power consumption.

More specifically, as shown in FIG. 3, the ink supply portion 8 includes a raising and lowing portion 84.

The raising and lowing portion 84 raises or lowers the sub-ink tank 81. For example, the raising and lowing portion 84 includes a support plate 84A (see FIG. 4) that supports the bottom surface of the sub-ink tank 81, and a raising and lowering mechanism (not shown) that raises and lowers the support plate 84A.

In addition, as shown in FIG. 3, the control portion 7 includes a lowering processing portion 71, a circulation processing portion 72, a detection processing portion 73, and a setting processing portion 74. A device including the image forming portion 3, the control portion 7, the ink supply portion 8, and the ink circulation portion 9 is an example of the liquid ejection device according to the present disclosure.

More specifically, the ROM 7B of the control portion 7 stores in advance an ink circulation program for causing the CPU 7A of the control portion 7 to function as each of the above-mentioned portions. The CPU 7A of the control portion 7 functions as each of the above-mentioned functional portions by executing the ink circulation program stored in the ROM 7B. Note that a part or all of the functional portions included in the control portion 7 may be configured with electronic circuits. In addition, the ink circulation program may be a program for causing a plurality of processors to function as the functional portions included in the control portion 7.

Note that the processing of each functional portion of the control portion 7 described below is executed for each recording head 30.

The lowering processing portion 71 lowers the water level F1 of the ink accommodated in the sub-ink tank 81 with respect to the nozzle 30A.

More specifically, the lowering processing portion 71 lowers the water level F1 of the ink using the raising and lowering portion 84.

In addition, the lowering processing portion 71 lowers the water level F1 of the ink in a case where the elapsed time since the last ejection of the ink by the ejection portion 36 exceeds a predetermined reference time. The reference time may be set depending on how easily the ink dries. That is, the reference time may be set to become shorter as the degree of ease of drying the ink increases.

As the water level F1 of the ink accommodated in the sub-ink tank 81 lowers with respect to the nozzle 30A, the water pressure (head pressure) of the ink in the nozzle 30A decreases. Therefore, the ink in the nozzle 30A is drawn into the pressurizing chamber 30B.

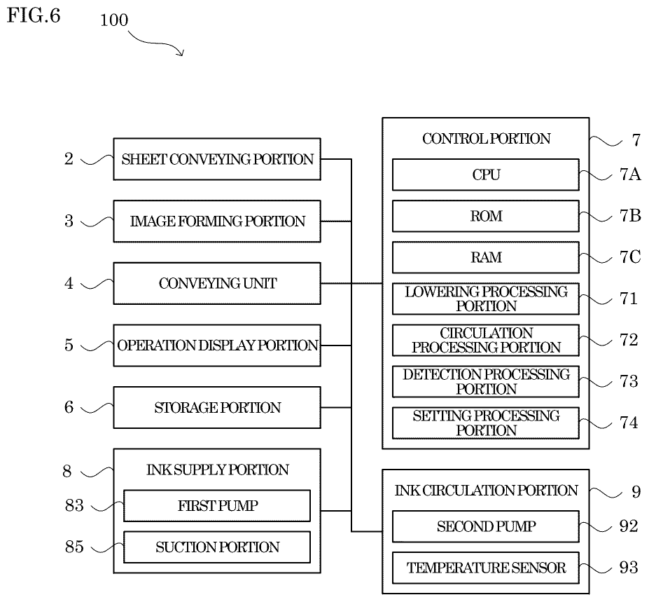

Note that, instead of the raising and lowing portion 84, the ink supply portion 8 may include a suction portion 85 (see FIG. 6) that sucks up a part of the ink accommodated in the sub-ink tank 81. For example, the suction portion 85 includes a pump that sucks up the ink accommodated in the sub-ink tank 81, an ink accommodating portion that temporarily accommodates the ink sucked up by the pump, and a guide flow path that guides the ink from the sub-ink tank 81 to the ink accommodating portion via the pump. In this case, the lowering processing portion 71 may lower the water level F1 of the ink using the suction portion 85.

The detection processing portion 73 detects the temperature of the ink.

For example, the detection processing portion 73 uses the temperature sensor 93 to detect the temperature of the ink.

The setting processing portion 74 sets a lowering amount of the water level F1 of the ink by the lowering processing portion 71 based on the detection result by the detection processing portion 73.

For example, in the image forming apparatus 100, table data indicating the correspondence between the temperature of the ink and the amount of lowering of the water level F1 of the ink is stored in advance in the storage portion 6. The lower the temperature of the ink, the stronger the surface tension of the ink water level formed in the nozzle 30A. When the surface tension becomes strong, it becomes difficult for the water level of the ink formed in the nozzle 30A to rise. Therefore, in the table data, a correspondence between the temperature of the ink and the amount of lowering of the water level F1 of the ink is determined such that the lower the temperature of the ink, the greater the amount of lowering of the water level F1 of the ink.

For example, in the table data, the correspondence between the temperature of the ink and the amount of lowering of the water level F1 of the ink is set such that the water level of the ink formed in the nozzle 30A reaches an upper end of the nozzle 30A (a boundary between the nozzle 30A and the pressurizing chamber 30B). Note that in the table data, a correspondence between the temperature of the ink and the amount of lowering of the water level F1 of the ink may be set such that the water level of the ink formed in the nozzle 30A is located below the upper end of the nozzle 30A.

For example, the setting processing portion 74 sets the amount of lowering of the water level F1 of the ink, which is corresponded to, in the table data, the temperature of the ink detected by the detection processing portion 73 as the amount of lowering of the water level F1 of the ink by the lowering processing portion 71.

Here, the lowering processing portion 71 lowers the water level F1 of the ink according to the setting result by the setting processing portion 74. Thus, regardless of the temperature of the ink, it is possible to raise the water level of the ink formed in the nozzle 30A to the upper end of the nozzle 30A.

Note that the lowering processing portion 71 may always lower the water level F1 of the ink accommodated in the sub-ink tank 81 by a constant lowering amount regardless of the temperature of the ink. In this case, the control portion 7 does not need to include the detection processing portion 73 and the setting processing portion 74.

The circulation processing portion 72 circulates the ink along a circulation path R21 passing through the ejection portion 36 after the water level F1 of the ink is lowered by the lowering processing portion 71.

More specifically, the circulation processing portion 72 uses the second pump 92 to circulate the ink along the circulation path R21.

In addition, the circulation processing portion 72 circulates the ink along the circulation path R21 in a case where the elapsed time since the last ejection of the ink by the ejection portion 36 exceeds the reference time.

### [Ink Circulation Process]

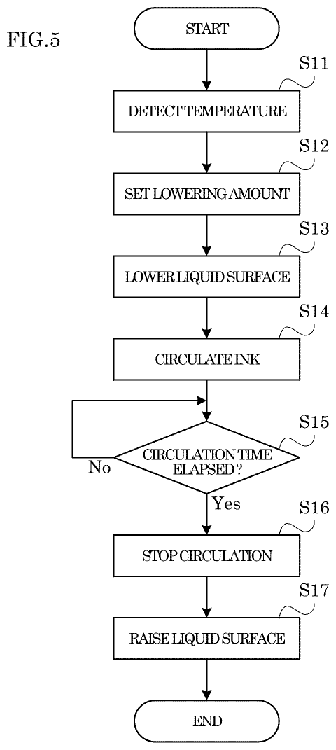

Hereinafter, with reference to FIG. 5, a liquid circulation method according to the present disclosure will be described along with an example of a procedure of an ink circulation process executed by the control portion 7 of the image forming apparatus 100. Here, steps S11, S12, and so on represent the numbers of processing procedures (steps) executed by the control portion 7. For example, the ink circulation process is executed every time the elapsed time since the last ejection of the ink by the ejection portion 36 exceeds a multiple of the reference time.

### <Step S11>

First, in step S11, the control portion 7 detects the temperature of the ink. Here, the process of step S11 is executed by the detection processing portion 73 of the control portion 7.

### <Step S12>

In step S12, the control portion 7 sets the amount of lowering of the water level F1 of the ink accommodated in the sub-ink tank 81 based on the detection result obtained by the process in step S11. Here, the process of step S12 is executed by the setting processing portion 74 of the control portion 7.

### <Step S13>

In step S13, the control portion 7 lowers the water level F1 of the ink accommodated in the sub-ink tank 81 with respect to the nozzle 30A in accordance with the setting result of the process in step S12. Here, the process of step S13 is an example of a lowering step according to the present disclosure, and is executed by the lowering processing portion 71 of the control portion 7.

### <Step S14>

In step S14, the control portion 7 circulates the ink along the circulation path R21 passing through the ejection portion 36 after the water level F1 of the ink is lowered by the process in step S13. Here, the process of step S14 is an example of a circulation step according to the present disclosure, and is executed by the circulation processing portion 72 of the control portion 7.

### <Step S15>

In step S15, the control portion 7 determines whether a predetermined circulation time has elapsed since the start of execution of the process in step S14.

Here, when the control portion 7 determines that the circulation time has elapsed (YES in S15), the control portion 7 moves the process to step S16. In addition, when the circulation time has not elapsed (NO in S15), the control portion 7 waits for the circulation time to elapse in step S15.

### <Step S16>

In step S16, the control portion 7 stops the circulation of the ink along the circulation route R21.

### <Step S17>

In step S17, the control portion 7 raises the water level F1 of the ink accommodated in the sub-ink tank 81 with respect to the nozzle 30A. More specifically, the control portion 7 raises the water level F1 of the ink to the position before the process of step S13 is executed.

In this way, in the image forming apparatus 100, the water level F1 of the ink accommodated in the sub-ink tank 81 is lowered with respect to the nozzle 30A, and after the water level F1 of the ink is lowered, the ink is circulated along the circulation path R21 passing through the ejection portion 36. Thus, compared to a configuration in which the ink in the nozzle 30A is sucked into the pressurizing chamber 30B using the piezoelectric element 30C, it is not necessary to continuously supply power to the piezoelectric element 30C in order to maintain the state in which the ink in the nozzle 30A is sucked into the pressurizing chamber 30B. Therefore, it is possible to suppress drying of the liquid surface of the ink in the nozzle 30A while suppressing power consumption.

Note that the liquid according to the present disclosure is not limited to the ink, and may also be a coating agent that covers the surface of an object that is an ejection target.

### [Supplementary Notes of the Disclosure]

Hereinafter, a summary of the disclosure extracted from the above-described embodiments will be added. Note that each configuration and each processing function described in the following supplementary notes may be selected and combined as desired.

### <Supplementary Note 1>

A liquid ejection device including: an ejection portion having a first accommodation space configured to accommodate a liquid and eject the liquid accommodated in the first accommodation space from an ejection port communicating with the first accommodation space; an accommodating portion having a second accommodation space below the ejection port and configured to accommodate the liquid to be supplied to the ejection portion, in the accommodating portion, a space above a water level of the liquid accommodated in the second accommodation space communicates with the atmosphere; a lowering processing portion configured to lower the water level of the liquid accommodated in the accommodating portion with respect to the ejection port; and a circulation processing portion configured to circulate the liquid along a circulation path passing through the ejection portion after the water level of the liquid is lowered by the lowering processing portion.

### <Supplementary Note 2>

The liquid ejection device according to supplementary note 1, further including a raising and lowing portion configured to raise and lower the accommodating portion, wherein the lowering processing portion lowers the water level of the liquid using the raising and lowing portion.

### <Supplementary Note 3>

The liquid ejection device according to supplementary note 1, further including a suction portion configured to suck up a part of the liquid accommodated in the accommodating portion; wherein the lowering processing portion lowers the water level of the liquid using the suction portion.

### <Supplementary Note 4>

The liquid ejection device according to any one of supplementary notes 1 to 3, further including a detection processing portion configured to detect a temperature of the liquid; and a setting processing portion configured to set a lowering amount of the water level of the liquid by the lowering processing portion based on a detection result by the detection processing portion, wherein the lowering processing portion lowers the water level of the liquid according to a setting result by the setting processing portion.

### <Supplementary Note 5>

The liquid ejection device according to any one of supplementary notes 1 to 4, wherein the lowering processing portion lowers the water level of the liquid in a case where an elapsed time since the last ejection of the liquid by the ejection portion exceeds a predetermined reference time, and the circulation processing portion circulates the liquid along the circulation path in a case where the elapsed time since the last ejection of the liquid by the ejection portion exceeds the reference time.

### <Supplementary Note 6>

A liquid circulation method executed by a liquid ejection device, the liquid ejection device including: an ejection portion having a first accommodation space configured to accommodate a liquid and eject the liquid accommodated in the first accommodation space from an ejection port communicating with the first accommodation space; and an accommodating portion having a second accommodation space below the ejection port and configured to accommodate the liquid to be supplied to the ejection portion, in the accommodating portion, a space above a water level of the liquid accommodated in the second accommodation space communicates with the atmosphere; the liquid circulation method including: a lowering step of lowering the water level of the liquid accommodated in the accommodating portion with respect to the ejection port; and a circulation step of circulating the liquid along a circulation path passing through the ejection portion after the water level of the liquid is lowered by the lowering step.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A liquid ejection device, comprising:
an ejection portion having a first accommodation space configured to accommodate a liquid and eject the liquid accommodated in the first accommodation space from an ejection port communicating with the first accommodation space;
an accommodating portion having a second accommodation space below the ejection port and configured to accommodate the liquid to be supplied to the ejection portion, in the accommodating portion, a space above a water level of the liquid accommodated in the second accommodation space communicates with the atmosphere;
a lowering processing portion configured to lower the water level of the liquid accommodated in the accommodating portion with respect to the ejection port; and
a circulation processing portion configured to circulate the liquid along a circulation path passing through the ejection portion after the water level of the liquid is lowered by the lowering processing portion.

2. The liquid ejection device according to claim 1, further comprising
a raising and lowing portion configured to raise and lower the accommodating portion, wherein
the lowering processing portion lowers the water level of the liquid using the raising and lowing portion.

3. The liquid ejection device according to claim 1, further comprising
a suction portion configured to suck up a part of the liquid accommodated in the accommodating portion; wherein
the lowering processing portion lowers the water level of the liquid using the suction portion.

4. The liquid ejection device according to claim 1, further comprising
a detection processing portion configured to detect a temperature of the liquid; and
a setting processing portion configured to set a lowering amount of the water level of the liquid by the lowering processing portion based on a detection result by the detection processing portion, wherein
the lowering processing portion lowers the water level of the liquid according to a setting result by the setting processing portion.

5. The liquid ejection device according to claim 1, wherein
the lowering processing portion lowers the water level of the liquid in a case where an elapsed time since the last ejection of the liquid by the ejection portion exceeds a predetermined reference time, and
the circulation processing portion circulates the liquid along the circulation path in a case where the elapsed time since the last ejection of the liquid by the ejection portion exceeds the reference time.

6. A liquid circulation method executed by a liquid ejection device, the liquid ejection device including:
an ejection portion having a first accommodation space configured to accommodate a liquid and eject the liquid accommodated in the first accommodation space from an ejection port communicating with the first accommodation space; and an accommodating portion having a second accommodation space below the ejection port and configured to accommodate the liquid to be supplied to the ejection portion, in the accommodating portion, a space above a water level of the liquid accommodated in the second accommodation space communicates with the atmosphere; the liquid circulation method including:
a lowering step of lowering the water level of the liquid accommodated in the accommodating portion with respect to the ejection port; and
a circulation step of circulating the liquid along a circulation path passing through the ejection portion after the water level of the liquid is lowered by the lowering step.
